(19) United States
(12) Patent Application Publication
(10) Pub. No.: US 2014/0304789 A1
(43) Pub. Date: Oct. 9, 2014

(54) CONVENIENT ONE-TIME PASSWORD

(71) Applicant: INTERNATIONAL BUSINESS MACHINES CORPORATION, Armonk, NY (US)

(72) Inventors: Philippe Kaplan, Le Rouret (FR); Georges-Henri Moll, Villeneuve-Loubet (FR)

(73) Assignee: International Business Machines Corporation, Armonk, NY (US)

(21) Appl. No.: 13/857,345

(22) Filed: Apr. 5, 2013

(51) Int. Cl. G06F 21/31; H04L 29/06

(52) U.S. Cl. CPC G06F 21/31; H04L 63/0838
USPC 726/7; 726/5

(57) ABSTRACT

Authenticating a human user in a computer system by performing the following steps: (i) determining a one-time password determination algorithm (OTPDA) of one of the following types: graphical, audible, decoder key based, language-based, general knowledge based, temporal, transformative arithmetic and/or a hybrid type; and (ii) revealing the OTPDA to the human user in human-comprehensible form. Revealing OTPDA is done by: (i) communicating the OTPDA itself to the human user, and/or (ii) confirming, to the human user, that the human user's choice for an OTPDA will be used. Preferably, the OTPDA is simple to remember and can be applied by the human user without resort to a computer or similar device.

### FIELD OF THE INVENTION

The present invention relates generally to the field of one-time passwords (OTPs), and more particularly to a one-time password system that relies, at least in part, on arithmetic and/or mathematical operations in determining an OTP.

### BACKGROUND OF THE INVENTION

Static, or fixed, passwords for authenticating human users to computer systems are known. In a static password authentication system, the password is generally a string of alphanumeric characters. The character string is often sufficiently short that the human user will easily memorize it. In some cases, the character string is so long that the human user writes it down for future reference. In either case, a static password generally does not change from one authentication instance to the next authentication instance. Each time the user is required to be authenticated, he will enter the same character string. The static character string will change on occasion. For example, some computer systems force the user to change the static password every three months. As a further example, in some systems, the human user is required to change her static password when a reset condition arises, such as when the password is forgotten or security is breached. Nevertheless, as can be seen from these examples, static passwords remain relatively constant from session to session.

One-time passwords (or OTPs) are known (see Definition, below). OTPs avoid a number of shortcomings that are associated with static passwords. For example, in contrast to static passwords, an OTP is generally not vulnerable to “replay attacks.” This means that a potential intruder who manages to record an OTP used to access a service or to conduct a transaction will not be able to reuse, or “replay,” the OTP for fraudulent authentication, because the OTP generally changes with each use.

Challenge-based OTPs are known. When using a challenge-based OTP to authenticate a user, the authenticating computer system provides an OTP challenge. Oftentimes, this OTP challenge is a string of characters. This OTP challenge string is provided to a device with logic that determines an OTP which is: (i) different than the OTP challenge string; but (ii) determinable from the OTP challenge string based upon an OTP determination algorithm that has been programmed into the human user's device. While the OTP determination algorithm (OTPDA) generally remains constant from one authentication to the next, the correct OTP response will generally change for each authentication because the OTP challenge string generally changes for each authentication. If the OTPDA does change, the human user's device must be re-programmed with the new OTPDA.

### SUMMARY

Embodiments of the present invention disclose a method, computer program product, and system for authenticating a human user in a computer system. The process of authentication includes: (i) determining a one-time password determination algorithm (OTPDA) that includes a first response portion instruction set (RPIS) that is of at least one of the following types: (a) graphical, (b) audible, (c) decoder key based, (d) language-based, (e) general knowledge based, (f) temporal, (g) transformative arithmetic, and/or (h) a hybrid type that includes at least one of the foregoing types; and (ii) revealing the OTPDA to the human user in comprehensible form. At the revealing step, the OTPDA is revealed by: (i) communicating the OTPDA itself to the human user, and/or (ii) confirming, to the human user, that the human user's choice for an OTPDA will be used. At least the revealing step is performed by the computer system running under software control.

### BRIEF DESCRIPTION OF THE SEVERAL VIEWS OF THE DRAWINGS

FIG. 1 is a schematic view of a first embodiment of a computer system according to the present invention;

FIG. 2A is a schematic view of a server computer sub-system portion of the first embodiment computer system;

FIG. 2B is a schematic view of a client computer sub-system portion of the first embodiment computer system;

FIG. 3 is a schematic view of a authentication module portion of the first embodiment computer system;

FIG. 4 is a flowchart showing a process according to an embodiment of the present invention;

FIG. 5A is a first screenshot generated by the first embodiment computer system;

FIG. 5B is a second screenshot generated by the first embodiment computer system;

FIG. 6A is a flowchart showing a process according to an embodiment of the present invention;

FIG. 6B is a flowchart showing a process according to an embodiment of the present invention;

FIG. 6C is a flowchart showing a process according to an embodiment of the present invention; and

FIG. 6D is a flowchart showing a process according to an embodiment of the present invention.

### DETAILED DESCRIPTION

The DETAILED DESCRIPTION section will be divided into the following sub-sections: (i) The Hardware and Software Environment; (ii) Operation of Embodiment(s) of the Present Invention; (iii) Further Comments and/or Embodiments; and (iv) Definitions.

I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

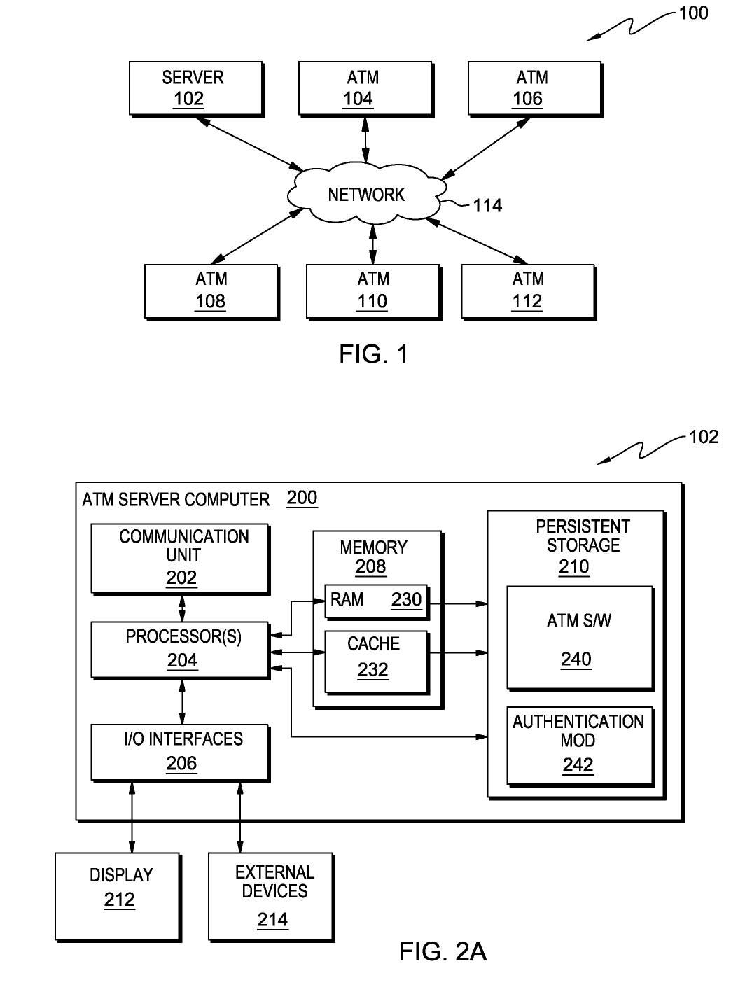

The present invention will now be described in detail with reference to the Figures. FIGS. 1, 2A, 2B and 3 collectively make up a functional block diagram of distributed data processing system 100, including: server computer sub-system 102; automated teller machine (ATM) sub-systems 104, 106, 108, 110, and 112; data communication network 114; ATM server computer 200; communications unit 202; processor set 204; memory component 208; RAM component 230; cache 232; persistent storage component 210; ATM software 240; authentication module (mod) 242; I/O (input/output) interface 206; display device 212; external devices 214; ATM 250; communication unit 252; ATM computer processor 254; ATM memory component 258; ATM RAM component 270; ATM cache 272; ATM persistent storage component 260; user-ATM server interface 280; ATM I/O interface 256; ATM display screen 262; ATM-style keyboard 264; password algorithm assignment sub-module (sub-mod) 302; password algorithms database 304; a password reveal sub-module 303; authentication session sub-module 310; challenge sub-sub-module 320; check user entry sub-sub-module 322; failed entry sub-sub-module 324; and successful entry sub-sub-module 326.

Authentication mod 242 and its various sub-mods implement OTPDA control and management according to an embodiment of the present invention. This will be discussed in detail in the next sub-section of this DETAILED DESCRIPTION section. For the rest of this sub-section, the hardware and software environment, in which authentication mod 242 operates, will be discussed in detail.

In many respects, ATM server computer sub-system 102 is representative of the various computer sub-systems of the present invention. Various components of ATM server computer sub-system will be discussed in the following paragraphs.

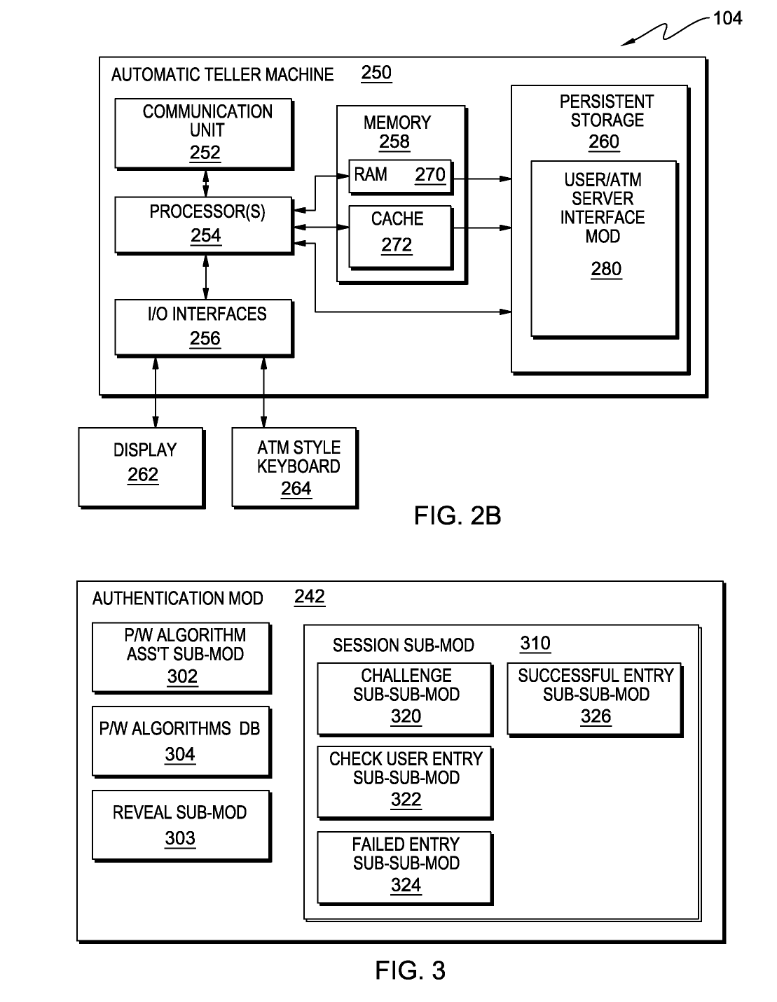

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. As shown in FIG. 2A, ATM software 240 is a collection of machine readable instructions and data that is used to manage and control the network of multiple ATM machines of system 100. Many portions of ATM software 240 are conventional, but some inventive aspects of software 240 (and especially its authentication mod 242) will be discussed in detail below.

Unlike ATM server computer sub-system 102, ATM sub-system is not a general purpose computer sub-system. However ATM sub-system 104 is similar to ATM computer sub-system 102 in many ways, as will become apparent in further discussion of ATM server computer sub-system 102, below. ATM sub-system 104 is an ATM sub-system of any type currently conventional or to be developed in the future. As shown in FIG. 2B, user/ATM server interface module 280 is a collection of machine readable instructions and data that is used to manage and control ATM 250. In this embodiment mod 280 is a conventional module used for controlling an ATM in the conventional manner. However, in alternative embodiments, the authentication software of the present invention could be implemented, in whole or in part, in mod 280 at the site of the ATM. Also, it should be understood that the present invention is not necessarily limited to ATM networks.

Moving back to sub-system 102 shown in FIG. 2A, network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client sub-systems.

It should be appreciated that FIGS. 1, 2A, 2B and 3, taken together, provide only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

Turning again to FIG. 2A, server computer sub-system 102 is shown as a block diagram with many double arrows. These double arrows (no separate reference numerals) represent a communications fabric, which provides communications between various components of sub-system 102 as shown in FIG. 2A. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

ATM software 240 and its constituent authentication mod 242 are stored in persistent storage 210 for access and/or execution by one or more of the respective computer processor(s) 204, usually through one or more memories of memory 208. Persistent storage 210 is at least more persistent than a signal in transit is, but the persistent storage may, of course, be substantially less persistent than permanent storage. Software 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as ATM sub-systems 104, 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface(s) 206 allows for input and output of data with other devices that may be connected locally in data communication with server computer 200. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, ATM software 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

II. Operation of Embodiment(s) of the present Invention

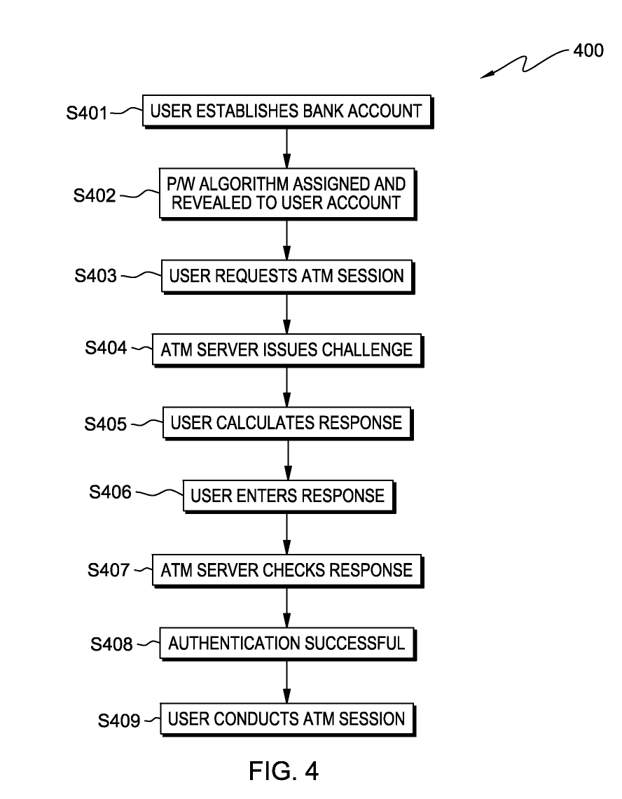

FIG. 4 is a flowchart depicting process 400 in accordance with an embodiment of the present invention. The various steps of process 400 will now be discussed in turn.

The process 400 begins at step S401 with a human user establishing a bank account. This bank account is accessible for management and control by the human user over network 114 and through the various geographically-distributed ATM sub-systems 104, 106, 108, 110, 112 (see FIG. 1). Bank account holders generally expect, and even demand, a high level of security despite the fact that the account can be accessed through publically-available ATM sub-systems 104, 106, 108, 110, 112. In most conventional systems, each user (that is, account holder) will have a static password that is used to allow only authorized access to her account.

One potential risk that comes with the use of publically-available ATM sub-systems 104, 106, 108, 110, 112 is called “shoulder surfing.” Shoulder surfing is when an unauthorized third party surreptitiously looks over the authorized user's shoulder in order to observe her entry of her conventional static password at an ATM sub-system located in a publically-accessible place. The surfer may even use a camera to record the user entering her password—this is a common method in reported attacks. Other security concerns also exist, such as where an unauthorized third party obtains access to the ATM sub-system 104 through a pen register, keystroke logger, or other device, to discover the user's key strokes, corresponding to her static password, after the authorized user has completed her transaction and left the vicinity of the ATM sub-system.

As mentioned above, an ATM network is just one example of a computer system where password security related concerns are relatively large. Other distributed data processing systems with heightened password-related security concerns include, but are not limited to: (i) military applications; (ii) mobile devices; (iii) gates; (iv) systems that allow access to a company's trade secrets; (v) systems that allow access to valuable copyrighted works; and/or (vi) other public machines.

Process 400 proceeds to step S402, where an OTP determination algorithm (OTPDA) is assigned to the user's account and “revealed” to the user of that account. More specifically: (i) password algorithm assignment sub-mod 302 (see FIG. 3) assigns the OTPDA to the user (that is, the bank account owner); and (ii) reveal sub-mod 303 (see FIG. 3) “reveals” the OTPDA to the user. The word “revealed” has been placed in quotations here because the word has a somewhat special meaning in the context of this document. More specifically, “revealed” means that: (i) an OTPDA determined for the user is communicated to the user in human understandable form; and/or (ii) the user's choice (for example, user-authored, user-chosen, user-customized, etc.) of an OTPDA is confirmed for the user as being the OTPDA that indeed will be used. In this embodiment, reveal sub-mod 303 reveals the assigned OTPDA through network 114 (see FIG. 1) to a display of the user's computer sub-system. For example, this may be done through interactive communications involving the bank's internet website.

With respect to assignment of the OTPDA by sub-mod 302, the specific ways in which this OTPDA assignment can be done include the following three ways: (i) sub-mod 302 determines an OTPDA by combining “response portion instruction sets” stored in password algorithms database 304 (see FIG. 3); (ii) sub-mod 302 may receive an OTPDA created by the user (or other party); and/or (iii) some combination of the foregoing two ways (for example, a user picks an OTPDA from a list of choices presented to the user). In this embodiment, the OTPDA, regardless of exactly which way it is assigned, must meet certain criteria as follows: (i) it must not be trivially easy to determine by spying on OTP password usage; (ii) it must include a “simple transformative arithmetic response portion instruction set;” and (iii) it must not include any “non-simple transformative arithmetic response portion instruction set.” The concepts of “response portion instruction set,” “transformative arithmetic,” “simple transformative arithmetic,” and “non-simple transformative arithmetic” will all be discussed in considerable detail below.

The OTPDA is the algorithm applied by the user in order to respond to an OTP challenge, or challenge string, in order to gain access to her bank account. The complexity of the OTP challenge and the OTPDA may vary depending upon: (i) the design of the system designer; and/or (ii) the desires of the user. Generally speaking, greater character length of a challenge string and/or greater complexity of an OTPDA leads to: (i) a greater level of security; and (ii) marginally increased difficulty for the user who must supply a correct challenge response.

An OTPDA, as that term is used herein, is made up of at least one response portion instruction set (RPIS). Generally, the OTPDA includes more than one RPIS. An RPIS operates on, at least a portion of, an OTP challenge (which may or may not be a string of characters) to produce, at least a portion of, a correct OTP response. There are many types of RPISs, some of which are: (i) graphical; (ii) audible; (iii) wild card; (iv) identity; (v) decoder key based; (vi) language-based; (vii) general knowledge based; (viii) temporal; and (ix) transformative arithmetic. The discussion below provides examples of some of the above-mentioned types of RPISs, but it will be mentioned here at the outset of this discussion that the inclusion of type (ix) transformative arithmetic type RPIS(s) in an OTPDA is a key feature of some embodiments. It should also be understood that a single RPIS may be properly characterized by more that one type, and that multiple type RPIS s are herein called hybrid type RPISs.

Graphical RPISs use graphical images to produce a correct OTP challenge response. One example of a graphical RPIS is an RPIS that: (i) presents the user with a drawing of a polygon as (a portion of) an OTP challenge; and (ii) requires the user to respond with the number of corners that the polygon has as the correct OTP response (or a portion thereof). Another example of a graphical RPIS is an RPIS that: (i) presents the user with a photograph of a horse as (a portion of) an OTP challenge; and (ii) requires the user to respond with the alphanumeric string “horse” or the alphanumeric string “pony” as the two possible correct OTP responses (or portions thereof). Many, many other types of graphical RPISs are possible.

Audible RPISs depend on sound. One example of an audible RPIS would be an RPIS where: (i) a user hears, through headphones, audio of a voice announcing a number; and (ii) requires the user to enter an alphanumeric string corresponding to the number announced in the audio as the correct OTP response (or portion thereof).

Wild card RPISs prompt the user to enter a random character as a portion of the OTP response. The wild card RPIS does not necessarily require an OTP challenge, but may be inserted as a placeholder, such as the RPIS, “insert a random character at the first place in the OTP response string.” While many OTPDAs include multiple RPISs, wild card RPISs especially rely on the presence of other RPISs, of a type other than the wild card type, to be included in the OTPDA. This is because an OTPDA with only wildcard RPISs would allow pretty much any response, and would therefore provide little security from unauthorized parties trying to guess at a correct OTP response.

Identity RPISs require the user to “parrot back” some portion of an OTP challenge string. One example of an identity type RPIS is an RPIS that: (i) presents a challenge string having two alphanumeric characters; and (ii) requires the user to use the second character of the challenge as the first character of a correct response string (the OTPDA in this example might have some other type of RPIS used to determine a second character of the correct response string). In more complex identity RPISs, a matrix (two or three dimensional) of characters may be provided and the user might have to select certain characters from the matrix, in a certain order, in order to formulate a correct response string. It is noted that an identity type RPIS may be especially vulnerable to spying because the response comes directly from the characters (or digits) of the challenge, which means that it can be easier to perceive a pattern of responses by viewing a number of challenges and correct responses. It is further noted that identity RPISs may use digits (as opposed to letters) in the challenge and response, but this use of numbers is not an example of transformative arithmetic (as will be explained more fully below). Another type of an identity-type RPIS is called “Captcha” (note: “Captcha” may be subject to trademark rights in various jurisdictions throughout the world and are used here only in reference to the products or services properly denominated by the marks to the extent that such trademark rights may exist).

Decoder key based RPIS s include OTP challenges where the OTP response is identified by a particular location relative to the OTP challenge character and a known arrangement of characters. For example, a decoder key based RPIS may use a 10-digit keypad of a digital phone as the known arrangement of characters and the location of the OTP response digit is opposite the 5 from the challenge digit. It should be noted that ATM style keyboard 264 shown in FIG. 2B is another device employing the 10-digit keypad. For such an RPIS, the OTP challenge of “6” yields the OTP response of “4.” Additional decoder key based rules may also apply, such as the OTP challenge digit of “5” prompts the OTP response of “0.”

Language based RPISs depend on language. One example of a language based RPIS would be an RPIS where: (i) a user receives a challenge string that is a word; and (ii) requires the user to enter a word that is the opposite of the challenge word as the correct OTP response (or portion thereof). Under this example, a challenge word of “empty” would have correct responses such as “full,” “filled” or “stuffed.”

General knowledge based RPISs depend on general knowledge. One example of a general knowledge based RPIS would be an RPIS where: (i) a user receives a challenge string that is a city; and (ii) requires the user to enter a string corresponding to a postal abbreviation of a state containing a city of that name as the correct OTP response (or portion thereof). Under this example, a challenge word of “San Francisco” would have a correct response “CA.”

Temporal RPIS s relate to time. An example of a temporal RPIS is an RPIS where the challenge comes in the form of a first beep and a second beep, and the correct challenge response is the approximate number of seconds between the two beeps.

Transformative arithmetic RPISs, which are key to some embodiments of the present invention, will now be discussed at some length. Transformative arithmetic RPISs are hereby defined as any RPIS that includes at least one “transformative arithmetic operation” (see DEFINITIONS section below). There are two types of transformative arithmetic operations: (a) simple; and (b) non-simple.

Some examples of simple transformative arithmetic operations include: (i) addition of small integers; (ii) subtraction of small integers; (iii) multiplication of small integers; (iv) division of small integers, where the quotient is an integer; (v) determination of the median of a small set of numbers; (vi) squares or cubes of small integers; and/or (vii) square roots, where the root is an small integer. Simple transformative arithmetic operations can be: (i) used as a simple transformative arithmetic RPIS (sometimes called a single-operation simple transformative arithmetic RPIS); (ii) combined together to form a simple transformative arithmetic RPIS (sometimes called a multiple-operation transformative arithmetic RPIS); and/or (iii) combined with simple non-mathematical operations to form a simple transformative arithmetic RPIS (sometimes called a hybrid transformative arithmetic RPIS).

Example (i): single-operation simple transformative arithmetic RPIS. An example of this type is an RPIS where one takes the first digit of the OTP challenge string and divides that digit by two (2) to form (a portion of) the OTP response string. Under this example: (i) challenge string=7654; and (ii) response=3.5.

Example (ii): multiple-operation transformative arithmetic RPIS. An example of this type is an RPIS where one calculates the mean average of the digits in the OTP challenge string to form (a portion of) the OTP response string. Under this example: (i) challenge string=7654; and (ii) response=5.5.

Example (iii) hybrid transformative arithmetic RPIS. An example of this type is an RPIS where one is presented with an OTP challenge graphic of a polygon and calculates the square of the number of sides of the polygon to form (a portion of) the OTP response string. Under this example: (i) challenge graphic=drawing of a pentagon; and (ii) response=25.

Some examples of non-simple transformative arithmetic operations include: (i) logarithms; (ii) square roots and higher-order roots; (iii) algebraic formulas (especially second and higher order); (iv) arithmetic of large numbers and/or many-digit fractions; (v) trigonometric functions; (vi) calculus functions; and (vii) most geometric formulas. For purposes of this document, non-simple transformative arithmetic operations are transformative arithmetic operation(s) that cannot be mentally performed by an average user of a given password-secured application. If a transformative arithmetic RPIS includes a non-simple transformative arithmetic operation then it cannot be considered as a “simple transformative arithmetic RPIS” (even if the RPIS includes simple transformative arithmetic operation(s) in addition to its non-simple transformative arithmetic operation(s)).

Many conventional OTPDAs use non-simple transformative arithmetic RPISs and this is one reason why machine-based logic (for example, a computer) at the user's end is required to determine a correct challenge response. Another reason that machine-based logic is conventionally required is that the OTPDA is never “revealed” to the user.

Returning to FIG. 4, where the appropriate OTPDA (in this example, including at least one simple transformative arithmetic RPIS and not including any non-simple transformative arithmetic RPISs) has been assigned and revealed at step S402. More specifically, for the discussion below, it will be assumed that the OTPDA consists of a single-operation simple transformative arithmetic RPIS as follows: add one (1) to the OTP challenge string. It is noted that this extremely simple OTPDA may not meet any requirement that the OTPDA be difficult to guess (as mentioned above), but it will be used as an example below because its simplicity will facilitate understanding. It is further noted that some more realistic simple transformative OTPDAs will be discussed in sub-section III of this DETAILED DISCUSSION section.

After step S402, processing proceeds to step S403 where the user approaches ATM sub-system 104 (see FIG. 1) and requests access to her bank account through ATM style keyboard 264 and display 262 (see FIG. 2B).

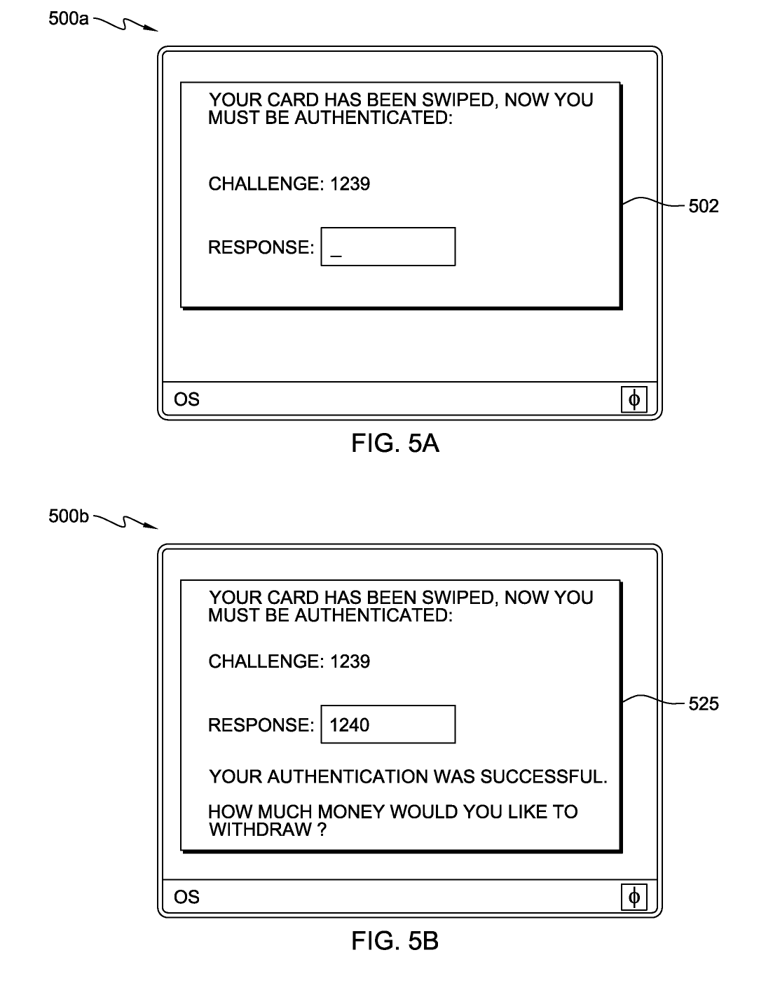

Processing proceeds to step S404 where challenge sub-sub-mod 320 of session sub-mod 310 (see FIG. 3) generates an OTP challenge suitable for the OTPDA corresponding to a particular account to create a correct OTP response. The form of the OTP challenge is constrained, in part, by the hardware on which the user will make an OTP response (for example, minimal keyboard, touchscreen, microphone, etc.). The OTP challenge is typically generated by: (i) random; and/or (ii) pseudo-random techniques. The technique used is a matter of: (i) design choice; and/or (ii) desired security level. Challenge sub-sub-mod 320 presents the OTP challenge to the user at ATM sub-system 104 through network 114 (see FIG. 1). This is shown at screenshot 500a of FIG. 5A, where OTP window 502 displays a four digit OTP challenge string of “1239.” While it is usually preferable to prepare the challenge at the time a user seeks to perform an instance of authentication, in some embodiments the successive challenges are determined ahead of time so that users can know in advance the next challenges and prepare a list of the next responses (probably good for mathematical or memory impaired persons).

Processing proceeds to step S405 where the user calculates, or otherwise determines, a correct response to the challenge based on the following: (i) the OTPDA revealed to her at step S402; and (ii) the OTP challenge string. As mentioned above, in this simplistic example, the OTPDA is a single RPIS having a single simple transformative arithmetic operation, with that operation being to add one (1) to the OTP challenge string number. Because of the use of a simple transformative arithmetic RPIS in the OTPDA, and further because of the lack of any non-simple transformative arithmetic RPISs in the OTPDA: (i) the correct OTP challenge response does not merely “parrot back” a portion of the OTP challenge; but (ii) the correct OTP challenge response is simple enough for the user to calculate in her head.

Processing proceeds to step S406 where the user enters a correct challenge response through ATM style keyboard 264 and display 262 (see FIG. 2B), through network 114 (see FIG. 1) and to be received by check user entry sub-sub-mod 322 of session sub-mod 310 (see FIG. 2A). In this example, the OTPDA mandates only one correct challenge response, which is 1240 (that is 1239+1). This is shown at screenshot 500b of FIG. 5B, where OTP window 525 displays the user's correct OTP response string: “1240.”

Processing proceeds to step S407 where check user entry sub-sub-mod 322 of session sub-mod 310 of authentication mod 242 of ATM server computer 200 (see FIGS. 2A and 3) checks the user's challenge response (received at step S406) for correctness. In this example, the user has indeed entered the correct challenge response. If the user had entered an incorrect response, then failed entry sub-sub-mod 324 would take one or more responsive actions, such as one or more of the following actions: (i) providing another OTP challenge to the user so the user has another chance to enter a correct OTP challenge response; (ii) suspending the user's account due to suspicion of unauthorized access; and/or (iii) notifying the user and/or bank management of the incorrect attempt at authentication.

Processing proceeds to step S408 where successful entry sub-sub-mod 326 of session sub mod 310 initiates an authenticated session where the user has access to her bank account due to her correct OTP challenge response entry. Alternatively, there may be other, additional security measures (for example, a retina scan, a second password) that must be met before an authenticated session can begin.

Processing proceeds to step S409 where the user, now authenticated using an OTP that she was able to calculate mentally, transacts her banking business securely according to methods now conventional or to be developed in the future.

The flowchart and block diagrams in the foregoing Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

III. Further Comments and/or Embodiment(s)

The features described and/or discussed in this sub-section relate to some embodiments of the present invention, and should not be taken as necessary requirements for all embodiments of the present invention as it is claimed or may come to be claimed.

This present disclosure relates to the password-based authentication domain, more specifically numerical one-time passwords (OTP) based on a challenge. In practice, a challenge is submitted to the user at each authentication. The user enters this challenge to a device located algorithm previously provided by the authentication party, and said algorithm returns a valid password for this challenge. As the challenge is different each time, the expected password is also different at each authentication. This makes the authentication process totally safe against replay attacks, thus easing the environment where the user enters the password.

Some embodiments of the invention use predictable sequences for the OTP challenge. These sequences may be based on a seed. The OTP challenge looks like a random challenge, but replays exactly the same value sequence from the same seed. The advantages are: (i) users can know in advance the next challenges and prepare a list of the next responses (this may apply well to mathematical or memory impaired persons); and (ii) in case of a security breach, the sequence can be replayed and investigated.

At least some embodiments of the present invention eliminate the need for a local device to provide the password by allowing the user to decide and enter a simple-to-remember algorithm (SRA). Although simple to remember, the algorithm remains secure and extremely hard to crack. It is based on a combination of random, arithmetic, and syntactic operations on the challenge. In some embodiments: (i) this algorithm is humanly operable by design; (ii) no device is required to run the algorithm; and (iii) the algorithm, once entered by the user, is also known by the authenticating party, which is able to check validity of the password.

In the following discussion, the examples of passwords and challenges are numerical only. This makes sense for the domain of machines in public areas, such as mobile devices, ATMs, gates, and so forth, where the user is likely to access a “small keyboard” (for example, numeric keypad). However, some embodiments can be extended to: (i) alpha-numeric passwords where the keyboard permits; and/or (ii) graphical passwords with, for example, a touch screen interface.

Some embodiments of the present invention do not require a local device to manage the password generation process, but maintain the security level of the challenge-based OTP. The algorithm is simple to remember, and even simpler than a static password. The algorithm is simple for the user to apply to the challenge. As the password is used only once, there is no need for the user to hide her user input while entering it.

A predefined generic instruction (PGI) is generally similar to an RPIS (as defined above), but in a PGI the instruction set is further required to be predefined and generic. A PGI may include the following operators: i) basic mathematical operations, such as add, subtract, multiply and divide a given integer; ii) digit operator that expresses the n-th digit (modulo challenge length) of the challenge; iii) count operator that counts the digits in the challenge that belong to a given digit set, such as the set of even numbers, or the set of numbers below 4, etc.; and iv) range operator that contains a series of integers between the given first and last numbers. The above-mentioned operators are only some examples of operators. The present disclosure focuses on operations capable of being remembered and applied by a human, not on the operations themselves.

A PGI will generally take the form of an expression based on the operators. To keep it simple to remember and to apply by a human, the expression should remain short. The SRA is a sequence of one or more (usually several) PGIs. In order to check the password, the computer should perform the PGI operations in sequence over the challenge. Then, verify that it gives the same result as the users answer, or password. For range operations, the computer should make a loop over all possible values. Accordingly, it may be advantageous to restrict the OTP algorithm to one range expression, to avoid exponential computation.

One example of an SRA is one with a 4-digit challenge and only one PGI, “digit(1)+digit(4).” This SRA simply requires that the first and last digits are added together to create the OTP. Example challenge/response sets are 2794/6, 5839/14, and 6122/8.

Another example of an SRA is one with a 4-digit challenge and three PGIs, including one range operator, “digit(1)+digit(2); range(0 . . . 9); digit(3)×digit(4).” This SRA requires that the user take the sum of the first 2 challenge digits, append a random digit, and append the product of the two last challenge digits. Example challenge/response sets are 2794/9136, 5831/1313, and 6122/704.

Yet another example of an SRA is “Digit(1)+Digit(3)+Digit(4); 9-digit(3); range(0 . . . 9).” This algorithm includes three PGIs separated by semi-colons. When this algorithm is applied to the four-digit challenge string above, 2784, one possible result is 1515, where the term used for the range operator, range(0 . . . 9), is 5. It should be noted that there are ten different authenticating OTP challenge responses available to the user, where the PGI, “range(0 . . . 9),” is any of 10 different digits. The first PGI is a basic mathematical operation, Digit(1)+Digit(3)+Digit(4). When this PGI is applied to the challenge 2784, it results in a two-digit response, 15. The four-digit challenge may invoke a response of a different character length. For example, the digits in locations 1, 3, and 4 may add up to a single digit response so that the correct OTP challenge response for the first PGI is a single digit. An example is the OTP challenge 5831, which includes a response of 9 for the first PGI. One acceptable OTP challenge response to the challenge 5831 is 979.

Yet still another example of an SRA is one with a 4-digit challenge and four PGIs, including three range operators, “3×(range(5 . . . digit(1))) mod 10; range(0 . . . 9); range(0 . . . 9); count(0,2,4,6,8)+4.” This SRA requires that the user select a number between 5 and the first challenge digit, multiply the selected number by 3, and keep the last digit of the resulting number, append a 2-digit number, append the count of even numbers in the challenge plus 4. Example challenge/response sets are 2794/9806, where the first digit is 9=3×3, 5831/5215, where the first digit is 5=5×3, keeping the last digit of the product, and 6122/8347, where the first digit is 8=6x3, keeping the last digit of the product.

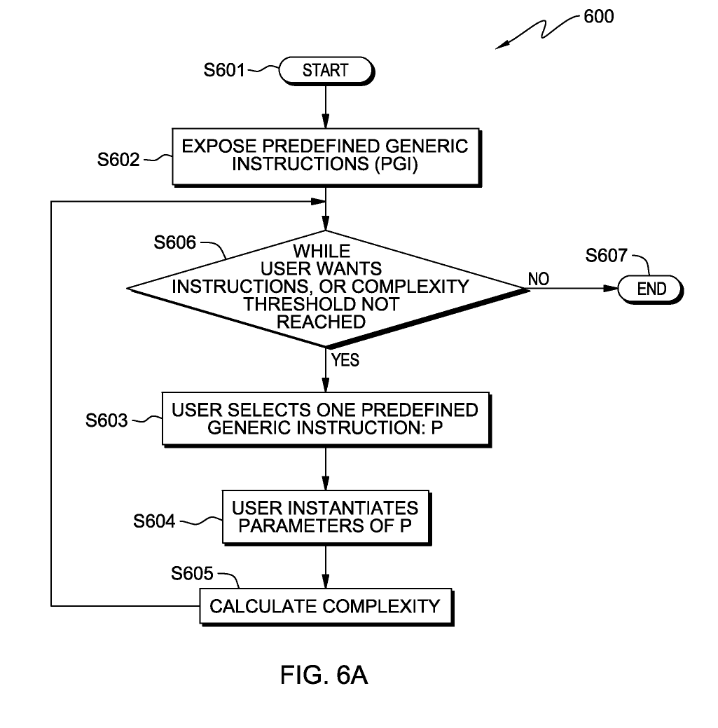

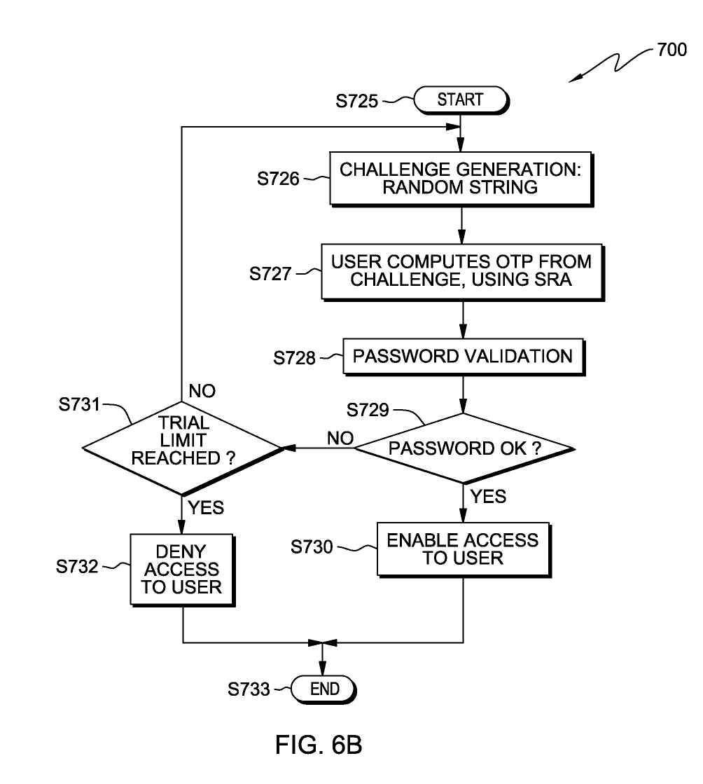

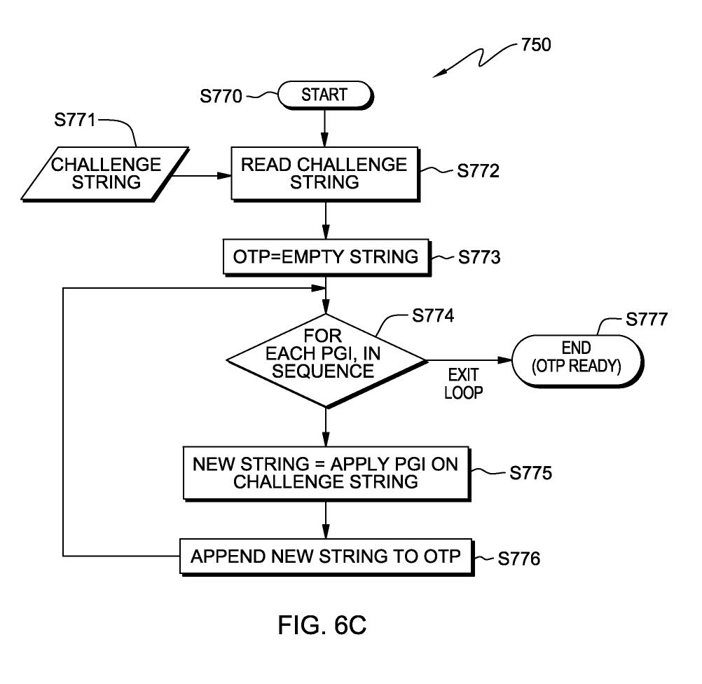

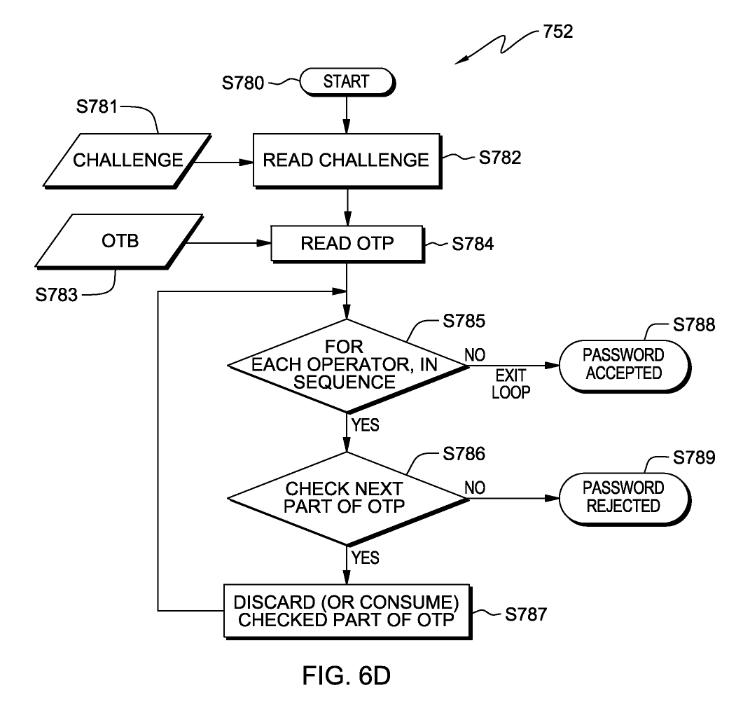

As shown in FIG. 6A, process 600 is one possible process for a user to create an OTPDA in step S402 of the process 400 in accordance with an embodiment of the present invention. In this example, the user creates a personalized SRA. In this example, the user is choosing an OTPDA, as opposed to choosing a plain password. The various steps of process 600 will now be discussed in turn.

The process 600 begins at step S601 and proceeds to step S602, where authentication module 242 determines which PGIs in password algorithm database 302 are available to the user. Password assignment sub-module 302 presents available PGIs to the user at ATM sub-system 104 through network 114 (see FIG. 1).

After step S602, processing proceeds to step S603, where password assignment sub-module 302 prompts the user to select one of the available PGIs from the menu. User selects an available PGI through ATM style keyboard 264 and display 262 (see FIG. 2B).

Processing proceeds to step S604, where the user enters the parameters of the selected PGI, if necessary, such as the range of numbers for the wild card PGI or the location of a particular challenge digit for the identity PGI.

Processing proceeds to step S605, where password algorithm assignment sub-module 302 determines the complexity level of the current OTPDA. There are many ways in which sub-module 302 may determine the complexity level of a given OTPDA. Some of which are discussed above. Regardless of the method of determining the complexity level of the OTPDA, algorithm assignment sub-mod 302 stores the complexity level as determined by sub-module 302 for further processing.

Processing proceeds to step S606, password algorithm assignment sub-module 302 compares the stored complexity level as determined in step S605 with a threshold complexity level. The threshold complexity level is pre-defined according to the design of the system. When the complexity level of the current OTPDA meets or exceeds the complexity threshold level, the process ends and assignment sub-module assigns the completed OTPDA to the user account. Once the OTPDA is assigned to the user account, reveal sub-module 303 reveals the OTPDA to the user through display 262. If the complexity threshold level is not met, processing returns to step S603, where the user selects another PGI. If the complexity threshold is met, processing ends at step S607.

According to process 600 of FIG. 6A, the user is not exposed to a new set of available PGIs, but the user simply selects from the previously presented PGIs. In another variation, step S605 may loop back to step S602 instead of step S606. This way, the assignment module 302 takes into account: i) all previously selected PGIs and/or ii) the complexity level of the current OTPDA when presenting the available PGIs to the user.

As shown in FIG. 6B, process 700 is one possible process by which the user attempts to access the OTP protected system. For example, process 700 is one possible process for use as step S403 in process 400 discussed above. The steps of process 700 will now be discussed in turn.

Process 700 begins at step S725 and proceeds to step S726, where session sub-mod 310 and challenge sub-sub-mod 320 (see FIG. 3) generate the OTP challenge. Challenge sub-sub-mod 320 displays the challenge to the user at ATM sub-system 104 through network 114 (see FIG. 1) on display 262.

Processing proceeds to step S727, where the user applies the previously revealed SRA to compute the OTP challenge response. The user enters the OTP challenge response through ATM style keyboard 264 and display 262 (see FIG. 2B).

Processing proceeds to step S728, where check user entry sub-sub-mod 322 validates the OTP challenge response. Sub-sub-mod 322 applies the OTPDA corresponding to the user's account to the OTP challenge generated for the present session by challenge sub-sub-mod 320. More than one correct OTP response may be calculated at this time. Sub-sub-mod 322 stores all the possible OTP responses.

Processing proceeds to step S729, where check user sub-sub-mod 322 compares the user-entered OTP response to the set of possible OTP responses. The user's OTP response is either accepted or rejected according to a comparison of the set of possible OTP responses.

If the password is rejected, the process proceeds to step S731, where the number of attempts to provide a valid OTP is compared to a predetermined attempt limit. If the attempt limit is not met, the process returns to step S726, where a new challenge is generated. If the attempt limit is met, the process proceeds to step S732, where the user is denied access to the system. The process then ends at step S733.

If the password is accepted, the process proceeds to step S730, where access to the system is enabled for the user. The process then ends at step S733.

As shown in FIG. 6C, process 750 is a process by which the user answers the OTP challenge by applying the previously revealed SRA. Process 750 is one possible way of performing step S405 of the process 400, discussed above. The various steps of process 750 will now be discussed in turn.

The process 750 begins at step S770 and proceeds to step S771, where session sub-mod 310 and challenge sub-sub-mod 320 generate the OTP challenge string. Challenge sub-sub-mod 320 displays the challenge to the user at ATM sub-system 104 through network 114 (see FIG. 1) on display 262.

Processing proceeds to step S772, where the user reads the challenge string through display 262.

Processing proceeds to step S773, where the OTP challenge response is empty, and proceeds to step S774, where the user recalls each PGI in the SRA in the order in which the PGIs were revealed to user.

Processing proceeds to step S775, where the user applies the first PGI to the challenge string to determine the first digit(s) of the OTP challenge response.

Processing proceeds to step S776, where the user appends the OTP challenge response to any previously determined OTP challenge response string.

Processing proceeds to step S774, where the next, if any, PGI is applied to the challenge string. Where no further PGIs are available, the process ends at step S777, where the user knows a correct OTP challenge response.

As shown in FIG. 6D, process 752 is where check user entry sub-sub-mod 322 of authentication mod 242 (see FIG. 3) applies the SRA to check for a valid answer to the challenge. Process 752 is one possible way to perform step S407 of process 400, discussed above. The various steps of process 752 will now be discussed in turn.

The process 752 begins at step S780 and proceeds to step S781, where the challenge sub-sub-mod 320 provides the challenge string to check sub-sub-mod 322 (see FIG. 3).

Processing proceeds to step S782, where check sub-sub-mod 322 reads the challenge string.

Processing proceeds to step S783, where the user enters an OTP challenge response through ATM style keyboard 264 and display 262 (see FIG. 2B).

Processing proceeds to step S784, where check sub-sub-mod 322 reads the OTP challenge response.

Processing proceeds to step S785, where check sub-sub-mod 322 parses the SRA by PGIs in the order that password assignment sub-mod 302 revealed the SRA to the user. When parsed, the check sub-sub mod 322 determines all correct OTP responses for the first PGI.

Processing proceeds to step S786, where check sub-sub mod 322 compares the list of correct OTP responses to the first part of the OTP challenge response read into memory in process step S784.

If the first part of the OTP challenge response does not match one of the correct OTP responses, processing proceeds to step S789, where failed entry sub-sub-mod 324 concludes the session by rejecting the password.

If the first part of the OTP challenge response matches one of the correct OTP responses, processing proceeds to step S787, where the first part of the OTP challenge response is discarded or consumed.

Processing returns to step S785, where check sub-sub mod 322 determines all correct OTP responses to the next part of the OTP challenge response read into memory in process step S784.

If the next part of the OTP challenge response does not match one of the correct OTP responses, processing proceeds to step S789, where failed entry sub-sub-mod 324 (see FIG. 3) concludes the session by rejecting the password.

If the next part of the OTP challenge response matches one of the correct OTP responses, processing proceeds to step S787, where the next part of the OTP challenge response is discarded or consumed.

Processing continues to process steps S785 through S787 until there are no more parsed PGI portions available to process. At that time, processing proceeds to step S788, where successful entry sub-sub-mod 326 accepts the OTP challenge response to authenticate the user.

Some embodiments of the present invention do not require a local device to embody the password generation, but maintain the security level of a challenge-based OTP. Some embodiments of the present invention do not require the user to answer the challenge with a classical password. Typical challenge-to-password methods focus on complexity, while the SRA approach described herein focuses on the simplicity/security trade-off.

The SRA is simple to remember; in some embodiments, it is even simpler than a usual password. The SRA is also simple for the user to apply. As the password is used only once, there is no need for the user to hide her user input while entering it. Some embodiments of the present invention eliminate the use of conventional lists containing the next challenges responses or passwords.

IV. Definitions

The following paragraphs provide definitions for certain term(s) used in this document:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: non-exclusive or; for example, A and/or B means that: (i) A is true and B is false; or (ii) A is false and B is true; or (iii) A and B are both true.

User: includes, but is not necessarily limited to, the following: (i) a single individual human; (ii) an artificial intelligence entity with sufficient intelligence to act as a user; and/or (iii) a group of related users.

One time password: any password that is used a small number of times (generally only once, but not necessarily only once); OTPs include, but are not limited to: (i) OTPs where a password response is a response string of characters based upon a challenge string of characters (the strings may be represented as graphics but will generally be character-based data), (ii) OTPs not based on a challenge, (iii) graphic-based OTPs, and (iv) non-visual OTPs.

Transformative arithmetic operation: any mathematical operation performed on a number (or symbol representing a number) that will certainly, or at least likely, change the value of that number; for example, “add zero” is not transformative arithmetic; as a further example, “raise to the second power” is “transformative arithmetic,” as that term is used herein, and this is true despite the fact that 1² is equal to 1.

What is claimed is:

1. A method of authenticating a human user in a computer system, the method comprising the steps of:
determining a one-time password determination algorithm (OTPDA) that includes a first response portion instruction set (RPIS) that is of at least one of the following types: graphical, audible, decoder key based, language-based, general knowledge based, temporal, transformative arithmetic and/or a hybrid type that includes at least one of the foregoing types; and
revealing the OTPDA to the human user in comprehensible form by: (i) communicating the OTPDA itself to the human user, and/or (ii) confirming, to the human user, that the human user's choice for an OTPDA will be used; and
at least the revealing step is performed by the computer system running under software control.

2. The method of claim 1 wherein the first RPIS is a simple transformative arithmetic RPIS.

3. The method of claim 1 wherein:
the OTPDA is a plurality of RPISs; and
all the plurality of RPIS s of the OTPDA are simple transformative arithmetic RPIS s.

4. The method of claim 1 wherein:
the OTPDA is a plurality of RPIS s;
each RPIS of the OTPDA is used to determine one digit of an authenticating response string made up of a plurality of digits.

5. The method of claim 1 further comprising the steps of:
issuing an OTP challenge to the human user;
receiving an OTP challenge response from the human user; and
checking the OTP challenge response to determine whether the OTP challenge response is an authenticating response based upon the OTPDA.

6. The method of claim 5 further comprising the step of:
after the issuing step and prior to the receiving step, the human user preparing an authenticating response based on the OPTDA without the use of any calculating device.

7. The method of claim 1 wherein at the determining step, the OTPDA is determined based, at least in part, upon input from the human user.

8. The method of claim 1 wherein at the determining step, the OTPDA is determined by the computer system running under software control.

9. The method of claim 1 wherein the OTPDA is a simple to remember algorithm.

10. A system for authenticating a human user in a computer system, the system comprising:
a processor set; and
a software storage device;
wherein:
the processor set is structured, programmed and/or connected to run software stored in the software storage device;
the software storage device has stored thereon an authentication module; and
the authentication module is programmed to:
determine a one-time password determination algorithm (OTPDA) that includes a first response portion instruction set (RPIS) that is of at least one of the following types: graphical, audible, decoder key based, language-based, general knowledge based, temporal, transformative arithmetic and/or a hybrid type that includes at least one of the foregoing types; and
reveal the OTPDA to the human user in comprehensible form by: (i) communicating the OTPDA itself to the human user, and/or (ii) confirming, to the human user in, that the human user's choice for an OTPDA will be used.

11. The system of claim 10 wherein the first RPIS is a simple transformative arithmetic RPIS.

12. The system of claim 10 wherein:
the OTPDA is a plurality of RPISs; and
all of the plurality of RPIS s of the OTPDA are simple transformative arithmetic RPIS s.

13. The system of claim 10 wherein:
the OTPDA is a plurality of RPIS s;
each RPIS of the OTPDA is used to determine one digit of an authenticating response string made up of a plurality of digits.

14. The system of claim 10 further comprising the authentication module programmed to:
issue an OTP challenge to the human user;
receive an OTP challenge response from the human user; and
check the OTP challenge response to determine whether the OTP challenge response is an authenticating response based upon the OTPDA.

15. The system of claim 10 wherein the OTPDA is determined by the computer system running under software control.

16. Software for authenticating a human user in a computer system, the software comprises:
a determining instruction set programmed to determine a one-time password determination algorithm (OTPDA) that includes a first response portion instruction set (RPIS) that is of at least one of the following types: graphical, audible, decoder key based, language-based, general knowledge based, temporal, transformative arithmetic and/or a hybrid type that includes at least one of the foregoing types; and
a revealing instruction set programmed to reveal the OTPDA to the human user in comprehensible form by: (i) communicating the OTPDA itself to the human user, and/or (ii) confirming, to the human user, that the human user's choice for an OTPDA will be used;
wherein:
the software is stored in a software storage device structured, connected and/or programmed to store data in a form less transitory than a signal in transit.

17. The software of claim 16 wherein the first RPIS is a simple transformative arithmetic RPIS.

18. The software of claim 16 further comprising:
an issuing instruction set programmed to issue an OTP challenge to the human user;
a receiving instruction set programmed to receive an OTP challenge response from the human user; and
a checking instruction set programmed to check the OTP challenge response to determine whether the OTP challenge response is an authenticating response based upon the OTPDA.

19. The software of claim 16 wherein the determining instruction set is programmed to determine the OTPDA based, at least in part, upon input from the human user.

20. The software of claim 16 wherein the OTPDA is a simple to remember algorithm.
